(19) United States
(12) Patent Application Publication
(10) Pub. No.: US 2003/0215628 A1
(43) Pub. Date: Nov. 20, 2003

(54) Long lasting outdoor tape

(75) Inventors: Jingjing Ma, Woodbury, MN (US); Michael D. Cartier, St. Paul, MN (US); Elda Garcia Bloemendal, Oakdale, MN (US); Simon S. Fung, St. Paul, MN (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 10/146,223

(22) Filed: May 14, 2002

(51) Int. Cl. B32B 7/12

(52) U.S. Cl. 428/343; 428/354

(57) ABSTRACT

The present invention is directed to an article comprising a backing, the backing comprising a multilayer film comprising a light shielding additive. In certain embodiments, the backing is greater than about 2% by weight light shielding additive, in some examples the backing is between about 3% to about 35% by weight light shielding additive.

The invention is also directed to an adhesive article comprising a backing and an adhesive layer on the backing, wherein the adhesive article has less than 10% adhesive transfer after 500 hours of weathering according to ASTM G155 Cycle 1.

### FIELD OF THE INVENTION

The present invention is directed to an adhesive article containing a multilayer film.

### BACKGROUND

Multilayer films have many uses. For example, a multilayer film may be used as a tape backing.

Cloth or cloth-like tapes are useful in numerous applications. For example, cloth-like tapes are used in medical applications, and in industrial and commercial applications such as in duct tapes, strapping tapes, electrical tapes, general utility tapes and in abrasives to name a few. Characteristics often desired in cloth-like adhesive tapes include a high tensile strength in the down and cross-web directions and ease of tearing by hand in both the down and cross-web directions along a substantially straight line without fraying.

Duct tapes generally comprise a cloth material carrying an adhesive layer on one surface. Many commercially available duct tapes additionally have an outer polymeric layer opposite the adhesive layer. The cloth layer has traditionally provided reinforcement and increased tensile strength. Generally, the backing is about 1-4 mils (25 to 102 micrometers) thick and provides the requisite dimensional stability to the tape. The polymeric layer has, in the past, been formed from a flexible plastic support, e.g. a cellulose ester such as cellulose acetate, cellulose triacetate, and the like; a polyester such as polyethylene terephthalate; or a polyolefin such as polyethylene or polypropylene. In many instances, the backing has been formed from polyethylenes, e.g. low density, high density, or linear low density polyethylene, including mixtures thereof.

Many examples of duct tapes are commercially available. Some examples of duct tapes have a multilayer polymeric layer as a backing. In one specific commercially available product, 3M Duct Tape 3939 commercially available from 3M Company, St. Paul, Minn., the polymeric layer is a coextruded 3 layer with 2 layers comprising low density polyethylene on either side of a core layer comprising a high density polyethylene blended with a low density polyethylene. One layer comprising low density polyethylene also comprises a release agent and the other layer comprises low density polyethylene. Another example, Sliontec 3430 duct tape, commercially available from Sliontec Corp. of Kawasaki, Japan, advertises as having an excellent resistance to weather and a long term general masking application over six months in Japan.

However, most duct tapes leave adhesive residue after outdoor use. This is especially a problem with long term (over 1 month) outdoor exposure.

### SUMMARY OF THE INVENTION

It is desirable to have a cloth tape, specifically a duct tape, which can be used during long term exposure outdoors and has less than 10% adhesive transfer after long term exposure. Therefore, the tape can be cleanly removed.

The present invention is directed to an article comprising a backing, the backing comprises a core layer having a first major surface, the core layer comprising a light shielding additive; a first layer comprising low density polyethylene on the first major surface of the core layer; and an adhesive layer on a surface of the first layer opposite the core layer. The core layer may comprise high density polyethylene, low density polyethylene, or a blend thereof. The article may additionally comprise a second layer comprising low density polyethylene, wherein the core layer is between the first layer and the second layer. In certain embodiments, the core layer has a second major surface opposite the first major surface, and the second layer is on the second major surface of the core layer. The light shielding additive may be carbon black.

In certain embodiments, the backing is greater than about 2% by weight light shielding additive, in some examples the backing is between about 3% to about 35% by weight light shielding additive.

The invention is also directed to an adhesive article comprising a backing and an adhesive layer on the backing, wherein the adhesive article has less than 10% adhesive transfer after 500 hours of weathering according to ASTM G155 Cycle 1.

### BRIEF DESCRIPTION OF THE DRAWINGS

FIG. 1 is a cross-sectional view of an adhesive tape of the present invention.

### DETAILED DESCRIPTION OF THE INVENTION

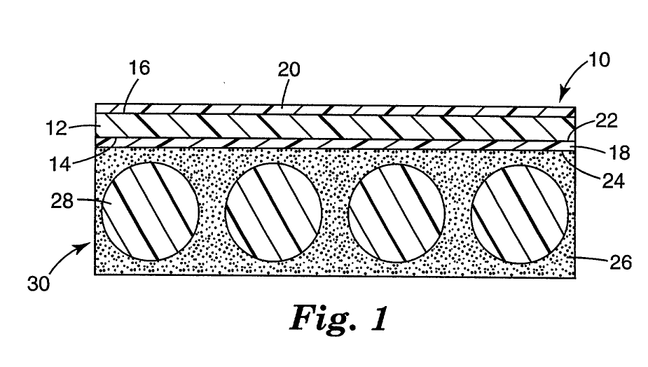

The multilayer film of the invention 10 as shown in FIG. 1 comprises a core layer 12. The multilayer film is generally between about 50 and about 100 micrometers thick. The core layer 12 comprises a polymer, for example high density polyethylene or low density polyethylene. In certain embodiments, the core layer 12 comprises a blend of high density polyethylene and low density polyethylene. Generally, the core layer is between about 25 and about 50 micrometers thick, for example between about 25 and about 35 micrometers thick. The core layer 12 has a first major surface 14 and a second major surface 16. A first layer 18 is in contact with the first major surface 14 of the core layer 12. The first layer 18 comprises low density polyethylene. Generally, the first layer 18 additionally comprises an adhesion promoter. The first layer may be between about 12 and about 18 micrometers thick. The core layer 12 may comprise a light shielding additive. In some embodiments, the first layer 18 additionally comprises a light shielding additive.

The embodiment of the invention shown in FIG. 1 additionally comprises a second layer 20. The core layer 12 is between the first layer 18 and the second layer 20. The second layer 20 generally comprises low density polyethylene and may comprise a light shielding additive. The second layer 20 may be between about 12 and about 18 micrometers thick. In the embodiment shown in FIG. 1, the second layer 20 is on the second major surface 16 of the core layer 12. The second layer 20 may additionally comprise a release additive. However, additional layers may be present between the core layer 12 and the second layer 20.

The first layer 18 has a first major surface 22 and a second major surface 24. The first major surface 22 of the first layer 18 is on the core layer 12. In the embodiment shown in FIG. 1, the multilayer film 10 had an adhesive layer 26 on the second major surface 24 of the first layer 18. The adhesive layer 26 additionally includes a scrim 28 embedded in the adhesive. The addition of adhesive layer 26 forms tape article 30 of the present invention. Generally, the tape article 30 is between about 200 and about 300 micrometers thick.

It was surprising to discover that the multilayer film of the invention works better as an adhesive article during long term outdoor use if the light shielding additive is in the core layer 12 or the second layer 20 as compared to a mutilayer backing when the light shielding additive is in the first layer 18 only. The tape article 30 of the present invention is more cleanly removed if the light shielding additive is not only in the first layer 18, but is either in the core layer 12, the second layer 20, either the core layer 12 or the second layer 20 in combination with the first layer 18, both the core layer 12 and the second layer 20 or in all three layers.

The core layer generally comprises a blend of high density and low density polyethylene. Generally, the core layer is between about 20% and about 90% by weight high density polyethylene, for example between about 40% and about 80% by weight high density polyethylene. High density polyethylene is made at low temperatures and pressures using Ziegler-Natta catalysts to form an essentially linear polymer with minimal branching and higher crystallinity. It is denser, tougher, and a higher melting point than low-density polyethylene. High density polyethylene can be purchased from several manufacturers, including Chevron Phillips Chemical Co., Houston Tex., or ExxonMobil Chemical Co., Houston Tex. Generally, high density polypropylene has a density between 0.94-0.97 grams/cm³ and a melting point temperature between 125° C. to 132° C., as described on page 2 and page 16 of the “Handbook of Polyethylene: Structures, Properties, and Applications (Plastics Engineering (Marcel Dekker, Inc.), 57.) by: Peacock, Andrew J., 2000.

The first and second layers comprise low-density polyethylene. Low-density polyethylene is prepared at higher temperatures and pressures, with free radical initiators, and is highly branched. The result is a less dense, lower melting point material. Generally, low density polypropylene has a density between 0.91-0.94 grams/cm³ and a melting point temperature between 98° C. to 115° C, as described on page 2 and page 16 of the “Handbook of Polyethylene: Structures, Properties, and Applications (Plastics Engineering (Marcel Dekker, Inc.), 57.) by: Peacock, Andrew J., 2000. Low-density polyethylene can be purchased from several manufacturers, including those listed under high-density polyethylene, above. Low density polyethylene also includes linear low density polyethylene.

The multilayer film additionally comprises a light shielding additive. The light shielding additive may be in the core layer, or the second layer, or both. In some embodiments, the first layer also comprises a light shielding additive.

The light shielding additive may be any number of known light shielding additives. Generally, these light shielding additives are materials through which visible and ultraviolet rays cannot transmit. Generally, the light shielding additive is present in greater than about 2% by weight of the multilayer backing. For example, the light shielding additive is present in the backing between about 3 and about 35% by weight. For example, a light shielding additive will block light wavelengths between about 200 nanometers and about 800 nanometers. Specifically, the light-shielding additive includes inorganic or organic pigment such as carbon black; iron oxide; zinc oxide; titanium oxide; mica; aluminum powder; aluminum paste/resin dispersed material; calcium carbonate; barium sulfate; pigments such as cadmium pigments, chrome yellow, iron red, cobalt blue, copper phthalocyanine pigments, monoazo or polyazo pigments, etc.; and a mixture thereof. Generally carbon black of various kinds, aluminum paste/resin dispersed material, mica, calcium carbonate, titanium oxide are used. Various types of carbon black, particularly furnace type carbon black, are most commonly used. A predispersed concentrate, such as a concentrate of carbon black in low density polyethylene is commercially available, for example from Ampacet Corp. (Tarrytown, N.Y.) and PennColor, Corp. (Doylestown, Pa.)

The first layer may comprise an adhesion promoter. The adhesion promoter is generally a polymer or copolymer that promotes adhesion while still being processable in low density polyethylene. Suitable examples include ethylene methyl acrylate copolymers such as those sold under the tradename EMAC from Voridian Chemical Co. (Kingsport, Tenn.), and ethylene butyl acrylate copolymers sold under the trade name EBAC. Similar polymers are sold by ExxonMobil Chemical of Houston, Tex., under the trade names ENABLE and OPTEMA.

Whichever adhesion promoter is used would be blended with the other components before being fed into the extruder. The amount added could be anywhere between 1% and 100%, depending on the level of adhesion needed. The level would be kept as low as possible because these materials are significantly more expensive than either low-density or high-density polyethylene.

The second layer may comprises a release additive. The release additive may be any release agent that may be processed with polyethylene. These additives are added as concentrates in polymers compatible with the polymer such as low-density polyethylene and linear low-density polyethylene. These include the class of materials called slip agents. Such materials are well known in polyethylene film processing, and are added to reduce the coefficient of friction of the film to allow the layers to slide on each other. Slip agents are generally long chain fatty acid amides, most often oleamide or erucamide. The material used in the film of this invention is ethylene bis-stearamide, commercially available from Polyfil Corp.

Alternately, the backside of the film may be coated with a low-adhesion backsize (LAB) coating, either during its manufacture, in a separate step, or during the manufacture of the tape. Such LAB materials are well known in the field of pressure-sensitive adhesives. LAB materials are expected to provide an appropriate level of release from the adhesive used and to not deleteriously affect the adhesive. A number of different LAB materials exist. Examples include long chain linear and branched hydrocarbon polymers such as acrylate, methacrylate, vinyl ester, and vinyl carbamate polymers as well as copolymers thereof; fluorocarbon copolymers; and silicones and silicone copolymers including silicones modified with epoxy groups or co-cured with isocyanates, polybutadiene, acrylic emulsions, etc.

The release agent may be present in the second layer in any desired amount but preferably ranges from 0.05 to 1.0% by weight and, more preferably, from 0.1 to 0.2% by weight.

The multilayer film may additionally comprise additives in any layer of the film or in combinations of layers. An example of an additive includes colorants in one of the layers to impart color to the film. Additionally, anti-blocking agents such as diatomaceous earth may be beneficial to the present invention. Inert fillers, such as calcium carbonate and clay, may also be added to the backing.

The multilayer film of the present invention may be formed by any conventional techniques, such as lamination and coextrusion. These include the coextrusion blown film process, the coextrusion cast film process, the coextrusion coating of scrim with a multilayer film, and sequential process for casting a free film, or for extrusion coating of the scrim.

Any suitable pressure sensitive adhesive composition can be used for this invention. Generally, the pressure sensitive adhesive has a level of cohesive strength necessary for a desired use. The pressure sensitive adhesive component can be any material that has pressure sensitive adhesive properties. Furthermore, the pressure sensitive adhesive component can be a single pressure sensitive adhesive or the pressure sensitive adhesive can be a combination of two or more pressure sensitive adhesives.

Pressure sensitive adhesives useful in the present invention include, for example, those based on natural rubbers, synthetic rubbers, styrenic block copolymers, polyvinyl ethers, poly (meth)acrylates (including both acrylates and methacrylates), polyolefins, and silicones.

The pressure sensitive adhesive may be inherently tacky. If desired, tackifiers may be added to a base material to form the pressure sensitive adhesive. Useful tackifiers include, for example, rosin ester resins, aromatic hydrocarbon resins, aliphatic hydrocarbon resins, and terpene resins. Other materials can be added for special purposes, including, for example, oils, plasticizers, antioxidants, ultraviolet (“UV”) stabilizers, hydrogenated butyl rubber, pigments, and curing agents.

In a specific embodiment the pressure sensitive adhesive is based on at least one thermoplastic elastomer, such as styrene-isoprene-styrene block copolymers and natural rubber.

The tape article of the present invention may additionally include a scrim. The scrim may be embedded in the multilayer film, embedded in the adhesive, or between the adhesive and the multilayer film. The scrim is generally a woven web. For example, the scrim may be selected from any known web materials, such as natural fibers (e.g. cotton and wool), synthetic fibers (e.g. polyester) and mixtures of natural and synthetic fibers. The scrim is usually between about 2 and about 8 mils thick (50.8-203.2 micrometer), however, the thickness of the scrim is dependant on the desired application. To maintain flexibility of the resulting tape, the scrim ordinarily has a thread count of about 5 to about 50 by about 5 to about 40. Specific scrims useful in the present invention include greige style 495 multifilament scrim with a thread count of 37×10 from American Fiber and Finishing, Inc., Albermarle, N.C. Other manufacturers who could provide a similar style scrim include Gross Kobrick Corp., Brooklyn, N.Y.

Scrims may be bonded or laminated to the multilayer film of the invention by, for example, pressing the film and the web together in a nip between a first roll and a second roll, (for example a rubber roll and a steel roll) and heated sufficiently to soften the material facing the metal roll. Other bonding means known in the art may also be used.

To form an adhesive article, the adhesive is coated onto at least a portion of the first layer of the multilayer film. The adhesive may be coated using conventional solvent coating techniques, coextrusion, calendaring or lamination. A release agent can be applied to the opposite side of the backing, if desired. When double-coated tapes are formed, the adhesive is coated onto at least a portion of both sides of the backing.

The adhesive article of the present invention is especially useful in conditions with prolonged exposure to ultraviolet light. Specifically, the adhesive article of the invention has less than 10% adhesive transfer after 500 hours of weathering according to ASTM G155 Cycle 1, as detailed in the examples section below. In specific examples, the adhesive article of the invention has less than 10% adhesive transfer after 1000 hours of weathering according to ASTM G155 Cycle 1. Additionally, the backing appearance after 1000 hour exposure generally shows no cracks.

### EXAMPLES

This invention is further illustrated by the following examples that are not intended to limit the scope of the invention. These examples are merely for illustrative purposes only and are not meant to be limiting on the scope of the appended claims. All parts, percentages, ratios, etc. in the examples and the rest of the specification are by weight unless indicated otherwise.

Test Methods

Total Light Transmission (TLT) Test

The adhesive on a strip of tape about 6 in long was moistened with a spray of industrial grade heptane. A blunt-edged scraper, such as a putty knife, was used to scrape the adhesive off the backing. The backing samples were then measured for Total Luminous Transmission according to ASTM Methods E903 and E891. Machine parameters are as follows: Scan Speed: 240 nm/min; Data Interval: 1.0 nm; Slit Width: 4.25 nm; Smooth: 6.00 nm/data pt; Mode(s): % T; data recorded from 250 nm to 830 nm. The TLT experiment was conducted on a Perkin Elmer Lambda 19 (Model #506583) and integration performed with a Lab Sphere Model RSA-PE-19a Integrating Sphere.

Thermal Gravimetric Analysis (TGA) Test

The TGA analyses were performed on a TA Instruments Model 2950 TGA Module with auto-TGA and Hi-Res Dynamic capabilities. Specifically, the method used was high resolution dynamic heating from room temperature to 800° C. at 50° C. per minute with high resolution sensitivity equal to 1.0 and resolution equal to 4.0° C.; with nitrogen atmosphere until 600° C. then switch to air atmosphere from 600° C. to 800° C. The instrument was controlled with TA Instruments Thermal Advantage Software, version 1.1A. Data from both DSC and TGA were analyzed with TA Instruments Universal Analysis Software, version 2.6D.

Differential Scanning Calorimetry (DSC) Test

The DSC analyses were performed on a TA Instruments Model 2920 DSC with Modulated DSC capability. The specific method used was: each sample was cooled to −50° C. and then heated at a rate of 5° C. per minute with a modulation of ±1° C. every 60 seconds to +300° C. The instrument was controlled with TA Instruments Thermal Advantage Software, version 1.1A. Data from both DSC and TGA were analyzed with TA Instruments Universal Analysis Software, version 2.6D.

Peel Adhesion Strength to Glass Test

A strip of pressure sensitive adhesive tape approximately 13 inches (33 cm) in length and 1 inch (2.54 cm) or less in width was applied to a clean glass surface (adhesive side facing the glass) using a 4.5 pound (2.04 kg) rubber roller by passing the roller over the test strip lengthwise at 90 in/min (228.6 cm/min) once. The test room conditions are kept at 73.4±3.6 deg. F. (23±2 deg. C.) and 50±2% R.H.

The 180° angle peel adhesion strength of each test strip was then measured using a slit/peel tester (Model number IMASS SP2000 available from Instrumentors, Inc, Strongsville, Ohio) at a peel rate of 90 inches/minute (228.6 cm/minute). The test strip was peeled back and the average peel force value was measured. This was done on two tape strips from each example. These two results were used to calculate an average peel adhesion strength value for each example.

Peel Adhesion Strength to Steel Test

A strip of pressure sensitive adhesive tape approximately 12 inches (30.5 cm) in length and 1 inch (2.54 cm) in width was applied to a clean panel surface (adhesive side facing the glass) using an automatic rolldown 4.5 pound rubber roller (2.04 kg)which operates at 12 inches per minute (5 mm/second) and travels one pass in each direction. The test room conditions are kept at 73.4±3.6 deg. F. (23±2 deg. C.) and 50±2% R.H to reduce variability.

The tensile tester (Model 1122 available from Instron Corp., Canton, Mass.) parameters were set to the following conditions:

1. Crosshead Speed: 12 inches/min. (304.8 mm/min.)

2. Chart Speed: approximately 5 inches/min. (127±25.4 mm/min.) where applicable.

3. Jaw Separation: 10 inches (25.4 cm)

4. Full Scale Load: 160 oz (44.5 N) Increase or decrease full scale load as needed to keep adhesion values between 20-85% of full scale on the chart.

The free end of the specimen was double backed and approximately 1 inch (2.54 cm) of the sample was peeled from the panel. The end of the panel from which the specimen was just removed was clamped into the lower jaw of the tensile tester. The specimen was clamped into the upper jaw of the tensile tester. The crosshead was set in motion (this step was initiated within 1 minute of the completion of the rolldown). This was done on two tape strips from each example. These two results were used to calculate an average peel adhesion strength value for each example.

Adhesive anchorage to backing (#2-bond) Test

A wide strip of double coated tape (approximately 2 inches wide by 12 inches long−5.1 cm×30.5 cm) without liner was centered lengthwise on the glass plate of a slip/adhesion tester (Model number IMASS SP2000 available from Instrumentors, Inc, Strongsville, Ohio). A strip of pressure sensitive adhesive sample tape approximately 12 inches (30.5 cm) in length and 1 inch (2.5 cm) width was centered on the double-coated tape with the adhesive side facing upwards. A strip of a #56 tape 0.5 inches wide by 13 inches long (1.3 cm×30.5 cm) (3M™ #56 Polyester Film Electrical Tape, 3M Co., St. Paul, Minn.) is placed adhesive side down against the test tape so that about 1 inch (2.5 cm) extends beyond the test tape. The samples were then rolled down using a 4.5 pound (2.04 kilogram (kg)) rubber roller by passing the roller over the tapes lengthwise in one direction. The test room conditions are kept at 73.4±3.6 deg. F. (23±2 deg. C.) and 50±2% R.H.

The left end of the standard tape sample was attached to the stirrup and the slack was removed by adjusting the platen. The 180° angle peel adhesion strength to remove 100% of the adhesive from the test strip to the standard tape was then measured using a slit/peel tester (Model number IMASS SP2000 available from Instrumentors, Inc., Strongsville, Ohio) at a peel rate of 90 inches/minute (228.6 cm/minute). Peel data was acquired over a 5 second test period after a two second delay to allow the initial startup force to stabilize. The test strip was peeled back and the average peel force value was measured. This was done on two tape strips from each example. These two results were used to calculate an average #2-bond value for each example.

Unwind Test

In order to measure the unwind of a sample, the sample needed to be in tape roll form. The unwind apparatus was attached to the carriage of the slip/adhesion tester (Model number IMASS SP2000 available from Instrumentors, Inc, Strongsville, Ohio). The clamp was adjusted for good alignment (ensuring that the tape cleared the platen). A roll of pressure sensitive adhesive sample tape 1 inch (2.5 cm) width or 2 inches width (5 cm) was placed on the unwind spindle and the unwind force was measured by running at 90 inches/min (228.6 cm/minute). The average value was scaled for a one inch wide sample and recorded for two different rolls for each example. These two results were used to calculate an average unwind value for each example.

Shear to Steel Test

Two clean 3×3×0.061 inch (7.6 cm×7.6 cm×0.155 mm) annealed stainless steel panels (Type 304, 2B bright from ChemInstruments, Fairfield, Ohio) were placed flush with each other. A strip of pressure sensitive adhesive tape approximately 6 inches (15.2 cm) in length and 0.5 inches (1.3 cm) or less in width was tabbed and placed on one test panel with light finger pressure. The tape sample was then rolled down onto the second panel using a 4.5 pound (2.04 kilogram) rubber roller by passing the roller over the test strip lengthwise twice in each direction. The test room conditions are kept at 73.4±3.6 deg. F. (23±2 deg. C.) and 50±2% R.H. The sample was then removed from the first panel by bringing the entire assembly to the edge of the lab bench and pressing downward between samples, at the edge of the first panel. An adapter hook was then placed over the end of the tape sample and double backed to overlap at least 1 inch (2.54 cm) of tape. The tape sample on the panel was trimmed to ½ inch (1.3 cm) length by using a razor blade in a cutoff block. The panel was then transferred to a shear stand that allows for a 2-degree backward tilt. A one-kilogram weight was hung on the adapter hook. The test was run to completion (weight falls). The time in minutes was recorded. The average value was recorded for two different samples from each example. These two results were used to calculate an average shear value for each example.

Accelerated Aging/Adhesion to Aluminum After Aging/Removability After Aging

Aluminum panels (7×28×0.64 cm) from Q-Panel Lab Products (ED-2.75×11×0.025 inch, 5052 H38, Westlake, Ohio) were used. Panels were cleaned with one wipe with heptane followed by one wipe with ethanol. Three specimens are placed on a panel and rolled down with one pass (1 up and 1 down) using a 4.5 lb roller. The sample panel was exposed for a set duration (250 hours or 500 hours) to ASTM G155 cycle 1 conditions. The exposure conditions are described in ASTM G155 Cycle 1.

Approximately 2 inches of the sample was removed by a 90° angle manual peel. The panel was visually inspected with the unaided eye for adhesive residue. The area covered by adhesive residue was noted as a % of the total surface. A rating from 1 to 5 for clean removability by hand was provided based on amount of adhesive transfer as detailed in Table 1.

TABLE 1
Rating System for Removability by Hand

| RATING | % Adhesive Transfer |
|---|---|
| 1 | 51%-100% |
| 2 | 31%-50% |
| 3 | 21%-30% |
| 4 | 11%-20% |
| 5 | 0%-10% |

Afterwards, the test panel was anchored to the glass carriage of a slip/adhesion tester (Model number IMASS SP2000 available from Instrumentors, Inc, Strongsville, Ohio) using double stick tape. The 180° angle peel force was measured by running at 12 inches/min (30.5 cm/minute) with 1 second delay and a 5 second averaging time. The peel force and the amount of adhesive residue, recorded as a % of total area, were noted. The tape backing appearance after weathering was also rated on a 5-point scale. See Table 2 for a description of the rating system.

TABLE 2
Rating for Backing Appearance after Accelerated Aging

| Rating | Backing Appearance |
|---|---|
| 1 | Severe cracks, disintegration |
| 2 | Cracks across entire width of backing |
| 3 | Cracks in the backing but do not cross entire width of backing |
| 4 | Wrinkles in backing, no cracks |
| 5 | Smooth surface, no wrinkling, no cracks |

TABLE 3
MATERIALS
Material abbreviations

| Component - Trade Name | Abbreviation | Manufacturer |
|---|---|---|
| Elastomer - Natural Rubber | CV60 | Natural rubber with a Mooney viscosity of |
| | | 60, RCMA Americas Inc., Norfolk, VA |
| Elastomer - Radial block | Radial BC | A styrene-isoprene radial block copolymer as |
| copolymer | | disclosed in U.S. Pat. Nos. 5,296,547 and |
| | | 5,393,787. |
| Liquid resin - Shellfles 371 | SF371 | Shell Chemical, Houston, TX |
| Tackifying Resin - Escorez | ES1304 | Exxon Chemical Company, Houston, TX |
| 1304 | | |
| Tackifying Resin - Escorez | ES2393 | Exxon Chemical Company, Houston, TX |
| 2393 | | |
| Antioxidant - Irganox 1010 | Irg1010 | Ciba-Geigy, Hawthorne NY |
| UV Stabilizer - Tinuvin 738 | Tinuvin738 | Ciba-Geigy, Hawthorne NY |
| Filler - Calcium Carbonate | SNOWHITE 12 | OMYA Canada, Perth, ON |
| (CaCO₃) | | |
| Filler - Titanium Oxide | Kronos 2020 | Kronos, Inc., Cranbury, NJ |
| (TiO₂) | | |
| Three layer PE film backing | ISO Poly Films | ISO Poly Films Inc., Gray Court, SC |
| High density polyethylene - | HiD 9650 | Chevron Phillips Chemical Co. LP, Houston, |
| Marflex PE | | TX |
| Low density polyethylene | LD 110 | ExxonMobil Chemical Co, Houston, TX |
| Carbon black-Black PE MB | Black 19717 | Ampacet Corp., Tarrytown, NY |
| Carbon black- Black PE MB | Black 19270 | Ampacet Corp., Tarrytown, NY |
| Antiblock agent | 10477F | Ampacet Corp., Tarrytown, NY |
| Pigment, Yellow | 13805 Yellow | Ampacet Corp., Tarrytown, NY |
| Pigment, Olive drab | Olive drab | Ampacet Corp., Tarrytown, NY |
| UV Inhibitor | 100654 UVI | Ampacet Corp., Tarrytown, NY |
| UV Inhibitor | 101443 UVI | Ampacet Corp., Tarrytown, NY |
| Adhesion promoter | EMAC SP2260 | Voridian Chemical Co., Kingsport, TN |
| Release agent | RAC-0500 | Polyfil Corporation, Rockaway, NJ |

### Backing Examples

### Examples B1-B6

Examples B1-B6 have a three-layer film backing construction detailed in Table 4 below. In all examples the total weight percent of carbon black represents additions from a master batch of 35% carbon black material in a linear low density polyethylene carrier, Black 19717. The total thickness of the film is comprised of 25% outside layer, 50% core layer and 25% for the inside layer. All examples have a total thickness of about 76.3 microns.

TABLE 4
Three-layer film backing construction of Examples B1-B6

| Example | B1 | B2 | B3 | B4 | B5 | B6 |
|---|---|---|---|---|---|---|
| Total Carbon | 1.9% | 1.9% | 2.0% | 2.0% | 1.9% | 1.9% |
| black wt. % | | | | | | |
| (Black 19717) | | | | | | |

Outside layer (Second Layer)

| | | | | | | |
|---|---|---|---|---|---|---|
| LD110 | 16.7% | 16.7% | 22.0% | 22.0% | 22.0% | 22.0% |
| Black 19717 | 5.3% | 5.3% | 0.0% | 0.0% | 0.0% | 0.0% |
| 10477F | 0.5% | 0.5% | 0.5% | 0.5% | 0.5% | 0.5% |
| 13805 Yellow | 2.5% | 2.5% | 2.5% | 2.5% | 2.5% | 2.5% |

Core layer

| | | | | | | |
|---|---|---|---|---|---|---|
| LD110 | 25.0% | 50.0% | 19.3% | 44.3% | 25.0% | 50.0% |
| HiD 9650 | 25.0% | 0.0% | 25.0% | 0.0% | 25.0% | 0.0% |
| Black 19717 | 0.0% | 0.0% | 5.7% | 5.7% | 0.0% | 0.0% |

Inside layer (First Layer)

| | | | | | | |
|---|---|---|---|---|---|---|
| LD110 | 12.5% | 12.5% | 12.5% | 12.5% | 7.2% | 7.2% |
| EMAC SP2260 | 12.5% | 12.5% | 12.5% | 12.5% | 12.5% | 12.5% |
| Black 19717 | 0.0% | 0.0% | 0.0% | 0.0% | 5.3% | 5.3% |

### Examples B7-B13

Examples B7-B13 have a three-layer film backing construction detailed in Table 5 below. In all examples the total weight percent of carbon black represents additions from a master batch of 35% carbon black material in a linear low density polyethylene carrier, Black 19717. The total thickness of the film is comprised of 25% outside layer, 50% core layer and 25% for the inside layer. All examples have a total thickness of about 76.3 microns.

TABLE 5
Three-layer film backing construction of Examples B7-B13

| Example | B7 | B8 | B9 | B10 | B11 | B12 | B13 |
|---|---|---|---|---|---|---|---|
| Total Carbon black | 0.0% | 0.2% | 0.8% | 6.0% | 12.0% | 1.9% | 1.9% |
| wt. % (Black 19717) | | | | | | | |

Outside layer (Second Layer)

| | | | | | | | |
|---|---|---|---|---|---|---|---|
| LD110 | 22.0% | 22.0% | 22.0% | 22.0% | 22.0% | 20.9% | 20.9% |
| 10477F Slip | 0.5% | 0.5% | 0.5% | 0.5% | 0.5% | 0.5% | 0.5% |
| 13805 Yellow | 2.5% | 2.5% | 2.5% | 2.5% | 2.5% | 2.5% | 2.5% |
| 100654 UVI | 0.0% | 0.0% | 0.0% | 0.0% | 0.0% | 1.1% | 0.0% |
| 101443 UVI | 0.0% | 0.0% | 0.0% | 0.0% | 0.0% | 0.0% | 1.1% |

Core layer

| | | | | | | | |
|---|---|---|---|---|---|---|---|
| LD110 | 25.0% | 24.5% | 22.7% | 7.9% | 0.0% | 22.8% | 22.8% |
| HiD 9650 | 25.0% | 25.0% | 25.0% | 25.0% | 15.7% | 25.0% | 25.0% |
| Black 19717 | 0.0% | 0.6% | 2.3% | 17.2% | 34.3% | 0.0% | 0.0% |
| 100654 UVI | 0.0% | 0.0% | 0.0% | 0.0% | 0.0% | 2.3% | 0.0% |
| 101443 UVI | 0.0% | 0.0% | 0.0% | 0.0% | 0.0% | 0.0% | 2.3% |

Inside layer (First Layer)

| | | | | | | | |
|---|---|---|---|---|---|---|---|
| LD110 | 12.5% | 12.5% | 12.5% | 12.5% | 12.5% | 6.1% | 6.1% |
| EMAC SP2260 | 12.5% | 12.5% | 12.5% | 12.5% | 12.5% | 12.5% | 12.5% |
| Black 19717 | 0.0% | 0.0% | 0.0% | 0.0% | 0.0% | 5.3% | 5.3% |
| 100654 UVI | 0.0% | 0.0% | 0.0% | 0.0% | 0.0% | 1.1% | 0.0% |
| 101443 UVI | 0.0% | 0.0% | 0.0% | 0.0% | 0.0% | 0.0% | 1.1% |

The film compositions of Examples B1-B 13 were prepared using a 5.08 cm (2 inch) blown film die with a three layer feedblock, and a cooling tower, all provided by Killion Extruders, Inc., Verona, N.J. The formulation for each layer of the film was fed at a temperature of ca. 170° C. into the feedblock using a separate 1.91 cm (¾ inch) extruder with an L/D=26 obtained from C. W. Braebender Instruments, Inc. of South Hakensack, N.J.

### Examples B14-B15

Examples B14-B15 have a three-layer film backing construction as shown in Table 6 below. In both examples the total weight percent of carbon black represents additions from a master batch of 50% carbon black material in a low density polyethylene carrier, Black 19270. The total thickness of the film is comprised of 25% outside layer, 50% core layer and 25% for the inside layer. All examples have a total thickness of about 76.3 microns. The film backings of Examples B14 & B15 were made in a similar process as described in Backing Examples B1-B13 processing, as described above.

TABLE 6
Three-layer film backing construction of Examples B14 & B15

| Example | B14 | B15 |
|---|---|---|
| Total Carbon black wt. % (Black | 3.8% | 3.8% |
| 19270) | | |

Outside Layer Composition (Second Layer)

| | | |
|---|---|---|
| LD110 | 21.0% | 21.0% |
| 10477XL | 0.50% | 0.50% |
| Olive drab | 2.50% | 2.50% |
| 100654 UVI | 0.38% | 0.38% |
| RAC-0500 | 0.00% | 1.00% |

Core Layer Composition

| | | |
|---|---|---|
| LD110 | 19.3% | 19.3% |
| HiD 9650 | 25.0% | 25.0% |
| Black 19270 | 5.0% | 5.0% |
| 100654 UVI | 0.8% | 0.8% |

Inside Layer Composition (First Layer)

| | | |
|---|---|---|
| LD110 | 9.63% | 9.63% |
| EMAC SP2260 | 12.50% | 12.50% |
| Black 19270 | 2.50% | 2.50% |
| 100654 UVI | 0.38% | 0.38% |

### Comparative Backing Examples CB1-CB6

Comparative backing examples CB1-CB6 were obtained by carefully removing the scrim and adhesive layer from the commercial duct tapes as described in Table 10, Comparatives C1-C6.

Tape Examples E1-E16

Adhesive composition of Examples E1-E16 are listed in Table 8. Tape samples were prepared using a twin-screw extruder (30 mm diameter, fully intermeshing, co-rotating extruder, available from Coperion Corp., Ramsey, N.J.). The following ingredients were fed into the throat of the extruder in the order given: all of the Elastomer; then 30 percent of the total Tackifying Resin; followed by a blend of Antioxidant, TiO₂ filler and the remaining 70 percent of the total Tackifying Resin; then the Liquid Resin SF371; and finally the remaining Filler, CaCO₃ and UV stabilizer, Tinuvin738. The temperature of zones 1-10 was progressively increased from 50° C. to 105° C. for 1-4 and 50° C. to 160° C. for 5-16. The melt mixture was passed through a 15.2 cm (6 in) wide contact die onto a polyester multi-filament scrim from American Fiber & Finishing Inc., Newberry, S.C. and a backing from ISO Poly Films Inc., Gray Court, S.C. which was corona treated on the inside layer. The die was maintained at 150° C. for Examples E1-E4 and 165° C. for Examples E5-E16, the die gap was 0.5 mm to 0.8 mm (20 mils to 30 mils). The coating weight is 18.8 milligrams/square centimeter (45 grains per 24 square inch). For Examples E1-E4, the adhesive side of the tape was then irradiated with 4 Megarads (Mrads) at 170 kiloVolts (kV) using an Electrocurtain CB-300 electron beam system (available from Energy Sciences, Incorporated, Wilmington, Mass.).

TABLE 8
Adhesive composition of Examples E1-E16

| | | | | | | UV | | |
|---|---|---|---|---|---|---|---|---|
| Example | Backing | Elastomer | Tackifying Resin | Liquid Resin | Antioxidant | Stabilizer | Filler | Filler |
| ID# | ID# | (parts) | (phr*) | (phr*) | (phr*) | (phr*) | (phr*) | (phr*) |
| | | CV60 | ES1304 | SF371 | Irg1010 | Tinuvin783 | CaCO₃ | TiO₂ |
| E1 | B14 | 100 | 80.2 | 0 | 2 | 1 | 30 | 2 |
| E2 | B14 | 100 | 80.2 | 0 | 2 | 1 | 50 | 2 |
| E3 | B14 | 100 | 80.2 | 0 | 2 | 1 | 100 | 2 |
| E4 | B14 | 100 | 90 | 0 | 2 | 1 | 100 | 2 |
| | | Radial BC | ES1304 | SF371 | Irg1010 | Tinuvin783 | CaCO₃ | TiO₂ |
| E5 | B15 | 100 | 89.9 | 9 | 2 | 1 | 100 | 2 |
| E6 | B15 | 100 | 89.9 | 9 | 2 | 1 | 100 | 2 |
| E7 | B15 | 100 | 89.9 | 9 | 2 | 1 | 100 | 2 |
| E8 | B15 | 100 | 89.9 | 9 | 2 | 1 | 100 | 2 |
| E9 | B15 | 100 | 89.9 | 9 | 2 | 1 | 100 | 2 |
| E10 | B15 | 100 | 89.9 | 9 | 2 | 1 | 100 | 2 |
| E11 | B15 | 100 | 89.9 | 9 | 2 | 1 | 100 | 2 |
| E12 | B15 | 100 | 101.5 | 11 | 2 | 1 | 100 | 2 |
| E13 | B15 | 100 | 101.5 | 11 | 2 | 1 | 100 | 2 |
| E14 | B15 | 100 | 100.0 | 0 | 2 | 1 | 100 | 2 |
| E15 | B15 | 100 | 108.3 | 0 | 2 | 1 | 100 | 2 |
| | | Radial | ES2393 | SF371 | Irg1010 | Tinuvin783 | CaCO₃ | TiO₂ |
| E16 | B15 | 100 | 108.3 | 0 | 2 | 1 | 100 | 2 |

*phr = parts per 100 parts of (elastomer)

### Examples E17-E18

The tape Examples E17 and E18 were prepared by a process known as a calendering process. Adhesive composition of Examples E17-E18 is the same as Example E10. Adhesive was compounded using a twin screw compounder as described in Examples 5-16 and directly transported to a preheated roller (191° C.) with surface speed of 7.62 m/min (25 fpm) and then coated onto the top of scrim/film backing.

### Examples E19-E32

Examples E19-E32 have the same adhesive composition as Example E16. The adhesive was coated in the same way as described in Examples E5-E16 on the backings shown in Table 9 below.

TABLE 9
Tape Examples E19-E32

| Tape Example | Backing used |
|---|---|
| E19 | B1 |
| E20 | B2 |
| E21 | B3 |
| E22 | B4 |
| E23 | B5 |
| E24 | B6 |
| E25 | B7 |
| E26 | B8 |
| E27 | B9 |
| E28 | B10 |
| E29 | B11 |
| E30 | B12 |
| E31 | B13 |
| E32 | B14 |

### Comparatives C1-C6

Comparatives C1-C6 are commercial duct tapes shown in Table 10 below.

TABLE 10
Comparative Examples C1-C6

| Example | Trade Name | Manufacturer | Tape Construction |
|---|---|---|---|
| C1 | Anchor AC57 | Intertape Polymer Group, | Scrim in adhesive on |
| | | Montreal, Canada | top of film backing. |
| C2 | Anchor AC47 | Intertape Polymer Group | Scrim in adhesive on |
| | | Montreal, Canada | top of film backing. |
| C3 | Tesa 53953 | Tesa Tape, Inc., | Scrim in adhesive on |
| | | Hamburg, Germany | top of film backing. |
| C4 | Shurtape PC668 | Shurtape Technologies, Inc., | Scrim in adhesive on |
| | | Hickory, NC | top of film backing. |
| C5 | Shurtape PC630 | Shurtape Technologies, Inc., | Scrim in adhesive on |
| | | Hickory, NC | top of film backing. |
| C6 | Slióntec 3430 | Slióntec Corp., | Scrim pre-glued on |
| | | Kawasaki, Japan | film backing. |

TABLE 11
Tape Performance and Appearance after 250 hours of
Weathering (ASTM G155 Cycle 1)

| | | | | Peel | Adhesive | Backing | Removal |
|---|---|---|---|---|---|---|---|
| | Backing | C-black w/w %, | Core | Adhesion | Transfer | Appearance | by Hand |
| Example | used | C-black location | Layer | N/m | Rating | Rating | Rating |
| E19 | B1 | 2%, outside | HDPE | 755 | 3 | 5 | 5 |
| E20 | B2 | 2%, outside | LDPE | 1033 | 5 | 5 | 5 |
| E21 | B3 | 2%, core | HDPE | 919 | 5 | 5 | 5 |
| E22 | B4 | 2%, core | LDPE | 830 | 5 | 5 | 5 |
| E23 | B5 | 2%, inside | HDPE | 757 | 7 | 5 | 5 |
| E24 | B6 | 2%, inside | LDPE | 1160 | 7 | 5 | 5 |
| E25 | B7 | 0.0%, core | HDPE | delam | 100 | 4 | 1 |
| E26 | B8 | 0.2% core | HDPE | 1970 | 30 | 5 | 5 |
| E27 | B9 | 0.8% core | HDPE | 906 | 7 | 5 | 5 |
| E21 | B3 | 2.0% core | HDPE | 919 | 5 | 5 | 5 |
| E28 | B10 | 6.0% core | HDPE | 572 | 7 | 5 | 5 |
| E29 | B11 | 12.0% core | HDPE | 1116 | 7 | 5 | 5 |
| E30 | B12 | 2.0%, inside* | HDPE | 985 | 5 | 5 | 5 |
| E31 | B13 | 2.0%, inside** | HDPE | 1024 | 7 | 5 | 5 |
| E32 | B15 | 5.0%, core | HDPE | 891 | 5 | 5 | 5 |
| | | 2.5% inside | | | | | |

*All layers contain UV stabilizer 100654 UVI
**All layers contain UV stabilizer 101443 UVI

TABLE 12
Tape Performance and Appearance after 750 hours of
Weathering (ASTM G155 Cycle 1)

| | | | | Peel | Adhesive | Backing | Removal |
|---|---|---|---|---|---|---|---|
| | Backing | C-black w/w %, | Core | Adhesion | Transfer | Appearance | by Hand |
| Example | used | C-black location | Layer | N/m | Rating | Rating | Rating |
| E19 | B1 | 2%, outside | HDPE | 1104 | 7 | 5 | 5 |
| E20 | B2 | 2%, outside | LDPE | 1450 | 6 | 5 | 5 |
| E21 | B3 | 2%, core | HDPE | 1051 | 5 | 5 | 5 |
| E22 | B4 | 2%, core | LDPE | 1154 | 7 | 5 | 5 |
| E23 | B5 | 2%, inside | HDPE | 765 | 9 | 5 | 5 |
| E24 | B6 | 2%, inside | LDPE | 1253 | 14 | 4 | 5 |
| E25 | B7 | 0.0%, core | HDPE | delam | 100 | 1 | 1 |
| E26 | B8 | 0.2% core | HDPE | delam | 33 | 5 | 2 |
| E27 | B9 | 0.8% core | HDPE | 1249 | 32 | 5 | 5 |
| E21 | B3 | 2.0% core | HDPE | 1051 | 5 | 5 | 5 |
| E28 | B10 | 6.0% core | HDPE | 965 | 8 | 5 | 5 |
| E29 | B11 | 12.0% core | HDPE | 1160 | 13 | 5 | 5 |
| E30 | B12 | 2.0%, inside* | HDPE | 1456 | 15 | 5 | 5 |
| E31 | B13 | 2.0%, inside** | HDPE | 1675 | 12 | 5 | 5 |
| E32 | B14 | 5.0%, core | HDPE | 1127 | 7 | 5 | 5 |
| | | 2.5% inside | | | | | |

*All layers contain UV stabilizer 100654 UVI
**All layers contain UV stabilizer 101443 UVI

TABLE 13
Tape Performance and Appearance after 1000 hours of
Weathering (ASTM G155 Cycle 1)

| | | | | Peel | Adhesive | Backing | Removal |
|---|---|---|---|---|---|---|---|
| | Backing | C-black w/w %, | Core | Adhesion | Transfer | Appearance | by Hand |
| Example | used | C-black location | Layer | N/m | Rating | Rating | Rating |
| E19 | B1 | 2%, outside | HDPE | 1174 | 8 | 5 | 5 |
| E20 | B2 | 2%, outside | LDPE | 1299 | 6 | 5 | 5 |
| E21 | B3 | 2%, core | HDPE | 1119 | 10 | 4 | 5 |
| E22 | B4 | 2%, core | LDPE | 1126 | 9 | 4 | 5 |
| E23 | B5 | 2%, inside | HDPE | 1161 | 11 | 4 | 4 |
| E24 | B6 | 2%, inside | LDPE | 1300 | 16 | 4 | 5 |
| E25 | B7 | 0.0%, core | HDPE | delam | 100 | 1 | 1 |
| E26 | B8 | 0.2% core | HDPE | delam | 100 | 4 | 1 |
| E27 | B9 | 0.8% core | HDPE | 1311 | 20 | 4 | 5 |
| E21 | B3 | 2.0% core | HDPE | 1119 | 10 | 4 | 5 |
| E28 | B10 | 6.0% core | HDPE | 786 | 7 | 4 | 5 |
| E29 | B11 | 12.0% core | HDPE | 1132 | 8 | 4 | 5 |
| E30 | B12 | 2.0%, inside* | HDPE | 1503 | 17 | 4 | 5 |
| E31 | B13 | 2.0%, inside** | HDPE | 1304 | 11 | 4 | 5 |
| E32 | B15 | 5.0%, core | HDPE | 1003 | 7 | 5 | 5 |
| | | 2.5% inside | | | | | |

*All layers contain UV stabilizer 100654 UVI
**All layers contain UV stabilizer 101443 UVI

As shown in Tables 11-13, carbon black in the outside layer and core layers (Examples E19-E22) provide the best protection to the backing and adhesive during aging as shown by excellent backing appearance and clean removal after 250 hr, 750 hr and 1000 hr accelerated aging. Carbon black in the inside layer (Examples E23 & E24) provided some protection compared to Example E25, without carbon black, but showed increased residue after 750 hr (E24) and 1000 hr weathering (E24 & E23).

HDPE in the core layer provides improved mechanical strength and is critical for clean removal after long term outdoor aging. The presence the HDPE in the core layer also prevents the low molecular weight ingredients, for example release agents, from migrating to other layers.

It is known that carbon black particle size and concentration play important roles in UV protection of the film backing. Backing examples B7 without carbon black showed very high TLT % in Table 14, which leads to very poor aging resistance as shown in Tables 11-13. For Example E25, which has no carbon black, the backing delaminated completely from the scrim and adhesive layer after 250 hr accelerated aging test. Backing Examples B8and B9, containing<2% carbon black showed low TLT % as shown in Table 14. However, Examples E26 and E27, made with these backings (B8 and B9), do not have adequate aging resistance shown as high adhesive transfer % and poor removability by hand. The tape sample made of the backing with 2.0% or higher carbon black content (Examples E21, E28-E29) showed greatly improved aging resistance, shown in Tables 11-13 by low adhesive transfer, excellent removability by hand and excellent backing appearance.

TABLE 14
Percent Total Luminous Transmission (% TLT) Backing Examples

| λ nm | B7 | B8 | B9 | B3 | B10 | B11 |
|---|---|---|---|---|---|---|
| Total C-Black | 0.0% | 0.2% | 0.8% | 2.0% | 6.0% | 12.0% |
| w/w % | | | | | | |
| 250 | 22.55 | 0.01 | 0.01 | 0.00 | 0.01 | 0.01 |
| 300 | 29.53 | 0.01 | 0.01 | 0.00 | 0.01 | 0.01 |
| 350 | 25.22 | 0.00 | 0.00 | −0.01 | 0.00 | 0.00 |
| 400 | 27.19 | 0.00 | 0.00 | 0.00 | 0.00 | 0.00 |
| 450 | 32.92 | 0.00 | 0.00 | 0.00 | 0.00 | 0.00 |
| 500 | 62.50 | 0.00 | 0.00 | 0.00 | 0.00 | 0.00 |
| 550 | 75.24 | 0.00 | 0.00 | 0.00 | 0.00 | 0.00 |
| 600 | 77.07 | 0.00 | 0.00 | 0.01 | 0.00 | 0.00 |
| 650 | 78.48 | 0.00 | 0.00 | 0.01 | 0.00 | 0.00 |
| 700 | 79.74 | 0.00 | 0.00 | 0.02 | 0.00 | 0.00 |
| 750 | 80.97 | 0.00 | 0.00 | 0.04 | 0.00 | 0.00 |
| 800 | 81.96 | 0.01 | 0.01 | 0.06 | 0.01 | 0.01 |

TABLE 15
Film Backing Constructions

| | | | | | | TGA | |
|---|---|---|---|---|---|---|---|
| | Backing Construction | | | DSC | | Weight | |
| | | Thickness | | Tₘ | | Loss % | % Residue |
| Example | Layer | (micron) | Color | (° C.) | Polymer | 600-800° C. | 800° C. |
| B14 | Outside | 15 | Olive | 108 | LDPE | 4.0 | 1.5 |
| | Core | 30 | Black | 127 | HDPE | | |
| | Inside | 15 | Black | | LDPE | | |
| CB1 | Outer | 32 | Silver | 79 | LDPE | 0.7 | 0.2 |
| | Inner | 34 | Silver | 110 | LDPE | | |
| CB2 | Outside | 20 | Silver | 114 | LDPE | 0.6 | −0.8 |
| | Core | 15 | Sliver | | | | |
| | Inside | 30 | Sliver | | | | |
| CB3 | Single | 45 | Silver | 107 | LDPE | 0.7 | 0.8 |
| CB4 | Outside | 130 | Red | 113 | LDPE | 0.4 | 0.5 |
| | Inside | 10 | Black | | | | |
| CB5 | Single | 63 | Silver | 108 | LDPE | 1.4 | 1.9 |
| CB6 | Outside | 37 | Silver | 104 | LDPE | 0.9 | 0.9 |
| | Inside | 40 | Black | | | | |

Table 15 shows the analytical results of backing example B14 in comparison to the commercial duct tape backings, CB1-CB6. Backing thickness was measured on a cross-section of the tape backing using a microscope. For thermal analysis, all backing samples tested are only film backings where adhesive and scrim were carefully removed before testing. DSC results in Table 15 show all commercial tape backings, CB1-CB6, are made of LDPE. Different from the current duct tape construction, the core layer of Example B14 contains high-density polyethylene (HDPE). In Table 15, TGA Weight Loss % from 600-800° C. relates to combustible fillers like carbon black and % Residue at 800° C. refers to inorganic mineral fillers like TiO₂ etc. The results show most of commercial tape backing contains <1% combustible fillers. The backings of commercial “outdoor tapes”, CB4 and CB6, contain 0.4% and 0.9% carbon black respectively, which is too low to completely shield sunlight during long-term outdoor aging. Table 16 shows CB1-CB6 have the noticeably higher TLT % compared to the current invention, B15.

TABLE 16
Percent Total Luminous Transmission (TLT %)

| λ nm | CB1 | CB2 | CB3 | CB4 | CB5 | CB6 | B15 |
|---|---|---|---|---|---|---|---|
| 250 | 1.72 | 9.70 | 16.74 | 0.03 | 9.47 | 0.01 | 0.00 |
| 300 | 9.61 | 18.02 | 19.83 | 0.25 | 17.11 | 0.00 | 0.00 |
| 350 | 15.85 | 19.42 | 20.15 | 0.50 | 16.94 | 0.04 | 0.01 |
| 400 | 18.11 | 18.94 | 20.15 | 0.08 | 15.36 | 0.21 | 0.00 |
| 450 | 18.03 | 18.68 | 19.81 | 0.10 | 14.33 | 0.50 | 0.00 |
| 500 | 18.01 | 18.53 | 19.51 | 0.02 | 13.53 | 0.79 | 0.00 |
| 550 | 17.89 | 18.39 | 19.24 | 0.00 | 12.95 | 1.04 | 0.00 |
| 600 | 17.68 | 18.15 | 18.89 | 2.38 | 12.35 | 1.25 | 0.00 |
| 650 | 17.50 | 17.96 | 18.60 | 15.97 | 11.84 | 1.46 | 0.00 |
| 700 | 17.26 | 17.73 | 18.32 | 20.44 | 11.39 | 1.71 | 0.01 |
| 750 | 17.08 | 17.64 | 18.15 | 23.60 | 11.05 | 1.95 | 0.00 |
| 800 | 16.94 | 17.50 | 18.03 | 26.13 | 10.73 | 2.20 | −0.01 |

Table 16 shows Light transmission spectra of the same backing samples used in thermal analysis. Backing Example B15 (which has the same carbon black load as B14) shows essentially zero total luminous transmission, TLT %, in a wavelength range from 250 nm to 800 nm. In contrast to this, most of tape backings from comparative duct tapes show as high as 10% to 20% TLT, which results from little or no opaque fillers. The backings of commercial “outdoor duct tapes”, CB4 and CB6 show up to 0.50% and 0.21% TLT in UV range (250-400 nm) and higher TLT % in visible light range (400-800 nm). These results are confirmed by thermal analysis, i.e., the high percentage carbon black in both core and inside layers of Example B14 backing efficiently shields sunlight while the low percentage of opaque fillers in C4 and C6 backings will not provide sufficient UV shielding for long-term outdoor aging.

TABLE 17
Tape Performance Testing

| | Adhesion | Adhesion | | | | Shear to |
|---|---|---|---|---|---|---|
| Exam- | to glass | to Steel | 2-Bond | Unwind | Thickness | Steal |
| ple | N/m | N/m | N/m | N/m | mm | min |
| C1 | 1204 | 832 | 1795 | 350 | 0.38 | 21 |
| C2 | 1248 | 876 | 2145 | 580 | 0.30 | 7 |
| C3 | 865 | 514 | N/A | 405 | 0.20 | 300 |
| C4 | 843 | 777 | 1598 | 427 | 0.28 | 308 |
| C5 | 886 | 799 | 2364 | 317 | 0.25 | 31 |
| C6 | 733 | 427 | 1270 | 941 | 0.33 | 111 |
| E1 | 710 | 479 | 1498 | 1008 | 0.25 | 238 |
| E2 | 696 | 450 | 1629 | 951 | 0.24 | 160 |
| E3 | 651 | 419 | 1762 | 748 | 0.24 | 597 |
| E4 | 790 | 411 | 1605 | 708 | 0.24 | 1655 |
| E5 | 565 | 457 | 2073 | 229 | 0.23 | 2368 |
| E6 | 735 | 544 | 1855 | 527 | 0.21 | 2253 |
| E7 | 800 | 572 | 1931 | 581 | 0.23 | 3599 |
| E8 | 784 | 560 | 1995 | 549 | 0.26 | 1652 |
| E9 | 772 | 572 | 2048 | 630 | 0.27 | 2520 |
| E10 | 832 | 715 | 1780 | 692 | 0.24 | 4000+ |
| E11 | 841 | 679 | 1974 | 689 | 0.25 | 4000+ |
| E12 | 982 | 866 | 2078 | 554 | 0.25 | 4000+ |
| E13 | 1060 | 871 | 1956 | 617 | 0.25 | 4000+ |
| E14 | 918 | 748 | 1728 | 540 | 0.23 | 4000+ |
| E15 | 1073 | 879 | 1643 | 585 | 0.24 | 4000+ |
| E16 | 1201 | 1024 | 1927 | 540 | 0.23 | 4000+ |
| E17 | 608 | 448 | 2697 | 367 | 0.28 | 5300+ |
| E18 | 558 | 307 | 2860 | 272 | 0.30 | 2216 |
| E32 | 1124 | 969 | 3065 | 291 | 0.24 | 337 |

TABLE 18
Tape Performance and Appearance after 250 hours Accelerated
Weathering (ASTM G155 Cycle 1)

| | Peel | | Backing | |
|---|---|---|---|---|
| | Adhesion | Adhesive | Appearance | Removal by |
| Example | N/m | Transfer % | Rating | Hand Rating |
| C1 | 602 | 25 | 4 | 5 |
| C2 | 625 | 75 | 4 | 3 |
| C3 | * | 100 | 4 | 1 |
| C4 | 725 | 5 | 5 | 5 |
| C5 | 506 | 100 | 4 | 1 |
| C6 | 148 | 100 | 5 | 1 |
| E1 | 899 | 75 | 5 | 5 |
| E2 | 387 | 10 | 5 | 5 |
| E3 | 767 | 50 | 5 | 5 |
| E4 | 818 | 25 | 5 | 5 |
| E5 | 565 | 5 | 5 | 5 |
| E6 | 727 | 5 | 5 | 5 |
| E7 | 766 | 5 | 5 | 5 |
| E8 | 642 | 5 | 5 | 5 |
| E9 | 711 | 5 | 5 | 5 |
| E10 | 867 | 5 | 5 | 5 |
| E11 | 920 | 5 | 5 | 5 |
| E12 | 866 | 5 | 5 | 5 |
| E13 | 924 | 5 | 5 | 5 |
| E14 | 769 | 5 | 5 | 5 |
| E15 | 1101 | 5 | 5 | 5 |
| E16 | 1161 | 5 | 5 | 5 |
| E17 | 566 | 5 | 5 | 5 |
| E18 | 355 | 5 | 5 | 5 |
| E32 | 891 | 5 | 5 | 5 |

*Peel adhesion value is too low to measure.

TABLE 19
Tape Performance Testing after 500 hours Accelerated Weathering
(ASTM G155 Cycle 1)

| | Peel | | Backing | |
|---|---|---|---|---|
| | Adhesion | Adhesive | Appearance | Removal by |
| Example | N/m | Transfer % | Rating | Hand Rating |
| C1 | * | 100 | 1 | 1 |
| C2 | 422 | 100 | 2 | 1 |
| C3 | * | 100 | 1 | 1 |
| C4 | 1269 | 100 | 5 | 4 |
| C5 | 346 | 70 | 3 | 1 |
| C6 | 25 | 80 | 5 | 1 |
| E1 | 989 | 50 | 4 | 5 |
| E2 | 604 | 40 | 4 | 5 |
| E3 | 818 | 40 | 5 | 5 |
| E4 | 943 | 40 | 5 | 5 |
| E5 | 721 | 5 | 5 | 5 |
| E6 | 746 | 5 | 5 | 5 |
| E7 | 973 | 5 | 5 | 5 |
| E8 | 790 | 5 | 5 | 5 |
| E9 | 1061 | 5 | 5 | 5 |
| E10 | 997 | 3 | 5 | 5 |
| E11 | 1011 | 3 | 5 | 5 |
| E12 | 1044 | 3 | 5 | 5 |
| E13 | 987 | 3 | 5 | 5 |
| E14 | 846 | 3 | 5 | 5 |
| E15 | 1192 | 3 | 5 | 5 |
| E16 | 1364 | 7 | 5 | 5 |
| E17 | 597 | 5 | 5 | 5 |
| E18 | 471 | 3 | 5 | 5 |
| E32 | 908 | 7 | 5 | 5 |

*Unable to measure Peel adhesion value due to sample failure during testing.

Tape testing results of Examples E1-E18 and E32 in Table 17 demonstrate excellent tape performance in terms of high shear and good adhesion to variety of substrates. Most of the comparative duct tapes failed after 250 hour accelerated aging, showing wrinkled or cracked backing, and leaving large amounts of sticky residues on the substrate. Although comparative C4 showed good tape appearance after 500 hour accelerated aging, the tape left 100% adhesive residue when pulled at 12 in/min during peel adhesion teasing. Additionally, Examples E1-E18 and E32 showed good tape integrity after 250 and 500 hour accelerated aging indicated by smooth tape surface, no observable disintegration of the backing, and strong/coherent adhesive. This demonstrates the duct tapes of this invention are suitable for long term outdoor taping without losing cohesive strength of the backing and adhesive. The tape construction of this invention can also be hand removed cleanly from the testing substrate after 1000 hour accelerated outdoor aging, which makes it very attractive for outdoor long lasting masking and protecting applications.

Various modifications and alterations of the present invention will become apparent to those skilled in the art without departing from the spirit and scope of the invention.

What is claimed is:

1. An article comprising
a backing, the backing comprising
a) a core layer having a first major surface, the core layer comprising a light shielding additive; and
b) a first layer comprising low density polyethylene on the first major surface of the core layer; and
an adhesive layer on a surface of the first layer opposite the core layer.

2. The article of claim 1 wherein the core layer comprises high density polyethylene.

3. The article of claim 1 wherein the core layer comprises low density polyethylene.

4. The article of claim 1 comprising a second layer comprising low density polyethylene, wherein the core layer is between the first layer and the second layer.

5. The article of claim 4 wherein the core layer has a second major surface opposite the first major surface, and the second layer is on the second major surface of the core layer.

6. The article of claim 4 wherein the second layer comprises a light shielding additive.

7. The article of claim 1 wherein the first layer comprises a light shielding additive.

8. The article of claim 4 wherein the second layer comprises a release additive.

9. The article of claim 1 comprising a colorant.

10. The article of claim 4 wherein the second layer comprises a colorant.

11. The article of claim 1 wherein the light shielding additive is carbon black.

12. The article of claim 1 wherein the backing is greater than about 2% by weight light shielding additive.

13. The article of claim 12 wherein the backing is between about 2% to about 35% by weight light shielding additive.

14. The article of claim 1 wherein the core layer is between about 25 and about 50 micrometers thick.

15. The article of claim 1 wherein the backing is between about 50 and about 100 micrometers thick.

16. The article of claim 1 wherein the adhesion promoter is a copolymer of ethylene and methyl acrylate.

17. The article of claim 1 comprising a scrim.

18. The article of claim 17 wherein the scrim is embedded in the adhesive layer.

19. The article of claim 1 wherein the adhesive is a pressure sensitive adhesive.

20. The article of claim 19 wherein the pressure sensitive adhesive is cross-linked.

21. The article of claim 19 wherein the pressure sensitive adhesive is a natural rubber based pressure sensitive adhesive.

22. The article of claim 19 wherein the pressure sensitive adhesive is a block copolymer based pressure sensitive adhesive.

23. The article of claim 19 wherein the pressure sensitive adhesive is a (meth)acrylic based pressure sensitive adhesive.

24. The article of claim 1 wherein the first layer comprises an adhesion promoter.

25. An article comprising
a) a backing, the backing comprising
i) a core layer having a first major surface and a second major surface;
ii) a first layer comprising low density polyethylene; and
iii) a second layer comprising low density polyethylene and a light shielding additive, wherein the core layer is between the first layer and the second layer; and
b) an adhesive layer in contact with the first layer.

26. The article of claim 25 wherein the second layer is in contact with the second major surface of the core layer.

27. The article of claim 25 wherein the second layer comprises a release additive.

28. The article of claim 25 wherein the first layer comprises an adhesion promoter.

29. The article of claim 25 comprising a scrim.

30. The article of claim 29 wherein the scrim is embedded in the adhesive layer.

31. The article of claim 25 wherein the adhesive is a pressure sensitive adhesive.

32. The article of claim 31 wherein the pressure sensitive adhesive is cross-linked.

33. The article of claim 31 wherein the pressure sensitive adhesive is a natural rubber based pressure sensitive adhesive.

34. The article of claim 31 wherein the pressure sensitive adhesive is a block copolymer based pressure sensitive adhesive.

35. The article of claim 31 wherein the pressure sensitive adhesive is a (meth)acrylic based pressure sensitive adhesive.

36. The article of claim 25 wherein the first layer comprises a light shielding additive.

37. The article of claim 25 wherein the core layer comprises a light shielding additive.

38. The article of claim 25 wherein the core layer comprises high density polyethylene.

39. The article of claim 25 wherein the core layer comprises low density polyethylene.

40. The article of claim 25 wherein the first layer comprises an adhesion promoter.

41. The article of claim 25 wherein the light shielding additive is carbon black.

42. An adhesive article comprising a backing and an adhesive layer on the backing, wherein the adhesive article has less than 10% adhesive transfer after 500 hours of weathering according to ASTM G155 Cycle 1.
